(19) United States
(12) Patent Application Publication
(10) Pub. No.: US 2009/0292885 A1
(43) Pub. Date: Nov. 26, 2009

(54) METHOD AND APPARATUS FOR PROVIDING ATOMIC ACCESS TO MEMORY

(75) Inventors: Jason Molgaard, Windsor, CO (US); Michael James, Longmont, CO (US); Bradford Lincoln, Boulder, CO (US)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/125,683

(22) Filed: May 22, 2008

(51) Int. Cl. G06F 12/14

(52) U.S. Cl. 711/152; 711/E12.098

(57) ABSTRACT

Apparatus for controlling atomic access to a memory includes an access request evaluator for receiving an atomic access request to an address in the memory from a client and determining whether to allow atomic access to the requested address. An access indicator indicates whether a select address is currently under atomic access in the memory, and an access release indicates whether the atomic access is completed at the select address. The access request evaluator enables the client atomic access to the requested address if the access indicator indicates that the requested address is currently not under atomic access.

### FIELD OF INVENTION

The present invention generally relates to digital systems having multiple processors, and in particular, to a system having multiple processors that have access to a common memory device.

### BACKGROUND OF THE INVENTION

Many digital systems such as hard disk controllers include multiple embedded systems having processors that are operatively connected to a common memory device. Frequently, there are occasions where more than one processor may want access to the same memory location at the same time. It is generally desirable to allow one processor to finish its operation with the memory device before the next one is allowed to take any action, so that the first operation is not interrupted. For example, in a situation where two processors each want to increment a counter, one processor needs to read the current value count, add one and then write it in the counter before the second processor performs its reading operation. Otherwise, if both processors read and write simultaneously, the counter might get incremented only by one, rather than by two as intended.

Where a processor is allowed to perform an operation on a particular memory location without any interruption from other processors is known as an atomic access. In an atomic access, an operation consisting of more than one individual instruction is carried out completely, without any interruption. For example, an operation in which three distinct steps of reading, modifying and then writing data to an address is treated as if it is one operation or step is an atomic access.

### SUMMARY OF THE INVENTION

The present invention is directed to controlling atomic access to a memory. One embodiment of the invention includes an access request evaluator for receiving an atomic access request to an address in the memory from a client and determining whether to allow atomic access to the requested address. An access indicator indicates whether a select address is currently under atomic access in the memory, and an access release indicates whether the atomic access is completed at the select address. The access request evaluator enables the client atomic access to the requested address if the access indicator indicates that the requested address is currently not under atomic access.

### BRIEF DESCRIPTION OF THE DRAWINGS

FIG. 1 is a block diagram showing a system incorporating an atomic access controller in accordance with one embodiment of the present invention;

FIG. 2 is a block diagram of an atomic access controller shown in FIG. 1;

FIG. 3 is a circuit diagram of an atomic access request evaluator shown in FIG. 2;

FIG. 4A is a flowchart describing a process for handling a read request portion of an atomic operation in the system shown in FIG. 1; and

FIG. 4B is a flowchart describing a process for handling a write request portion of an atomic operation in the system shown in FIG. 1.

### DETAILED DESCRIPTION OF THE PREFERRED EMBODIMENTS

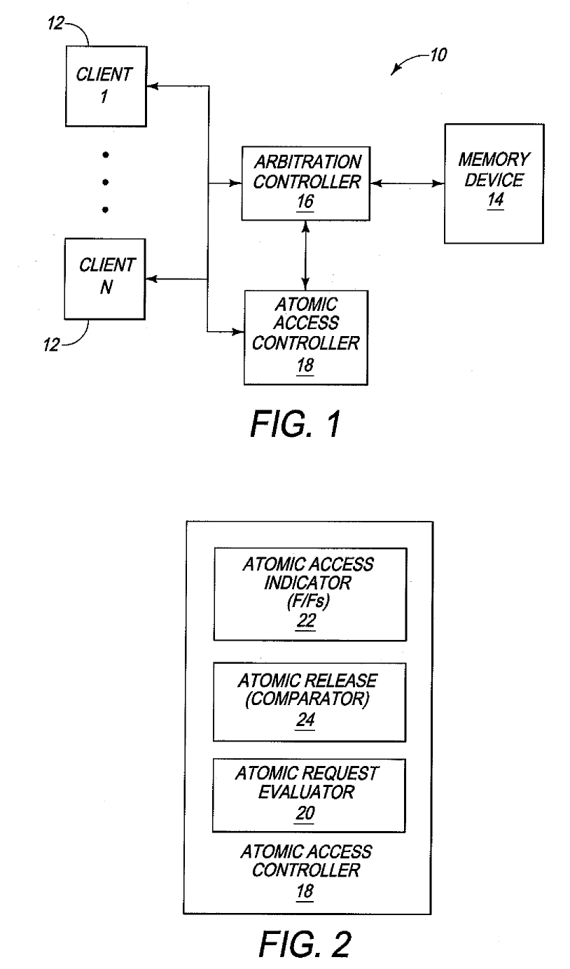

Turning now to FIG. 1, a digital system 10 in accordance with one embodiment of the present invention includes a number of clients 12 (clients 1 to N, where N is greater than or equal to 2) operatively connected to a memory device 14, via an arbitration controller 16 and an atomic access controller 18. The digital system 10 may be any system such as a hard disk controller in a disk drive, a network router, a switch, or any other hardware systems in which multiple client devices share the resources of a common memory device.

The clients 12 are hardware devices such as processors or state machines which may be embedded in the primary system. The memory device 14 is a data storage device such as a RAM or a flash memory that are capable of having its contents modified. The atomic access controller 18 sends information to the arbitration controller 16 for determining whether an atomic access is issued a grant. The arbitration controller 16 decides which client 12 will have access to the memory device 14, and which request will get serviced by sending a grant or an acknowledgement back to the client.

The arbitration controller 16 is implemented in a logic circuit which is communicatively connected to the clients 12 and the atomic access controller 18. The arbitration controller 16 receives read and write requests from the clients 12 by way of the atomic access controller 18 and grants access to the memory device 14 based on a predetermined method for granting access. In the preferred embodiment, the arbitration controller 16 employs a priority encoded methodology for determining access by the clients 12. As such, a single grant is generated in response to the highest priority request from the clients 12. However, other arbitration schemes may also be used, such as round robin or other known methods. The arbitration controller 16 is implemented in hard-wired logic.

Turning now to FIG. 2, the atomic access controller 18 includes an atomic access request evaluator 20, an atomic access indicator 22 and an atomic access release 24. The atomic access request evaluator 20 receives requests for atomic access to a specific address in the memory device 14 from the clients 12. If no other atomic operation is currently in process, the atomic access request evaluator 20 takes no action and allows the arbitration controller 16 to arbitrate access to the requested address of the memory device 14. If, however, an atomic operation is already in progress, the atomic access request evaluator 20 masks out all requests from the clients 12 that are requesting atomic access. As a result, the atomic requests are excluded from consideration for arbitration by the arbitration controller 16 until the prior atomic operation is completed.

The atomic access release 24 determines when an atomic access to a particular address in the memory device 14 is completed, and clears the atomic access indicator 22. A cleared atomic access indicator 22, informs the atomic access request evaluator 20 that an atomic access resource is available, so that a new atomic owner (of an address in the memory device 14) can be selected. The identity of the client 12 and the address to which the atomic access is requested is stored in the atomic access indicator 22.

More specifically, the atomic access indicator 22 tracks the atomic access in progress with a busy flag, the identity of the client 12 that is conducting the atomic access, and the addresses in the memory device 14 subject to the atomic access. In the preferred embodiment, the busy flag is implemented as a flip-flop element, indicating that an atomic operation is in progress when the flip-flop is asserted. Likewise, the owner of an atomic access may be binary encoded into the minimum number of flip-flop elements necessary to track N clients 12, but could also be one-hot encoded into N flip-flops. The address of the memory device 14 being subject to atomic access is also stored in flip-flops.

The atomic access release 24 implements a comparator circuit (not shown) that compares the write address requested by a client 12 with the read address previously stored in atomic access indicator 22. When the read and write addresses match, and there is an atomic access in progress (as indicated by the busy flag in the atomic access indicator 22), it is concluded that the write request is part of the atomic access. The atomic access release 24 then clears the busy flag in the atomic access indicator 22, indicating that the atomic operation is completed.

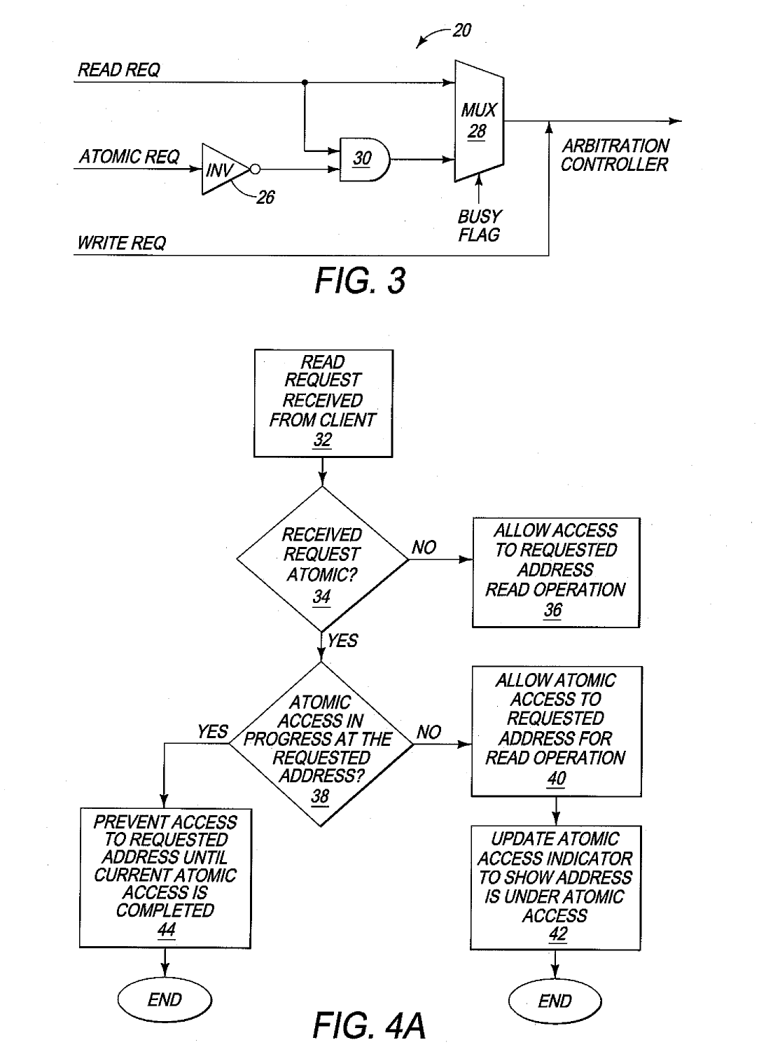

As shown in FIG. 3, the atomic access request evaluator 20 includes an inverter 26 for inverting the atomic requests from clients 12 to form a mask. Clients 12 that are requesting atomic access get a mask value of 0 as a result of this inverter 26, and clients not requesting atomic access will have a mask value of 1. The read requests from clients 12 are simultaneously sent to a multiplexor 28 and to a logical AND operation 30, along with the output from the inverter 26. The result of the logical AND operation 30 is that the read request will get masked to 0 if the client 12 is requesting an atomic access. The state of the busy flag from atomic access indicator 22 determines whether the unmodified read requests pass or the atomic masked requests pass through the multiplexer 28 to the arbitration controller 16. When there is already an atomic access, the masked read requests are passed to arbitration controller 16, so that the request is not acted on by the arbitration controller.

The atomic access request evaluator 20 also receives write requests from the clients 12. Unlike the handling of read requests, the atomic access request evaluator 20 merely routes the write requests to the arbitration controller 16, without consideration as to whether the write request is for atomic access to the memory 14.

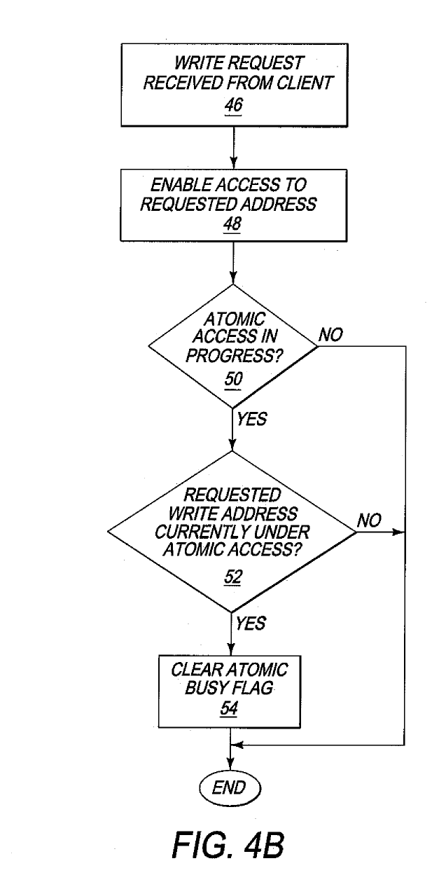

Turning now to FIGS. 4A and 4B, an atomic access operation performed in the digital system 10 is described in accordance with one embodiment of the present invention. It should be understood that an atomic access operation involves a read-modify-write operation of a piece of data stored in the memory device 14. As such, an atomic access operation begins with the arbitration controller 16 and the atomic access controller 18 receiving a read request from one of the clients 12 (Block 32). If the read request is not atomic (Block 34), the atomic access request evaluator 20 enables the arbitration controller 16 to perform arbitration, if necessary, and allows the client 12 to access the requested address of the memory device 14 for the read operation (Block 36).

However, if the received read request is an atomic read request, the atomic access request evaluator 20 determines from the atomic access indicator 22 whether there is an atomic access currently in progress (Block 38). If an atomic access is not in progress, the atomic access request evaluator 20 allows the arbitration controller 16 to evaluate the request, and upon successful arbitration, enable the requesting client 12 to access the requested address of the memory device 14 for the read operation (Block 40). The atomic access indicator 22 is also updated to show that the address requested by the client 12 is currently under atomic access (Block 42) and the busy flag is set. If, however, an atomic access is in progress at the requested address (Block 38), the atomic access request evaluator 20 prevents the atomic read request from being presented to the arbitration controller 16 for arbitration, and waits to process the requested atomic access until the current atomic access process ends (Block 44).

Turning now to FIG. 4B, when a write access request is output from one of the clients 12 subsequent to the read operation described in FIG. 4A, the write request is received by the arbitration controller 16 and the atomic access request evaluator 20 (Block 46). The arbitration controller 16 enables the client 12 to access the requested address in the memory device 14 (block 48).

The atomic access request evaluator 20 then checks the atomic access indicator 22 to determine whether there is an atomic access currently in progress in the memory device 14 (Block 50). If no atomic access is in progress, the write process is finished.

If, however, there is an atomic access pending, the atomic access release 24 compares the requested write address with the atomic address stored in atomic access indicator 22 to determine whether the requested write address is currently under atomic access (Block 52). If the two addresses do not match, the requested write address is not currently under atomic access, and the write process comes to an end.

However, if a match is detected, the atomic access release 24 clears the busy flag in the atomic access indicator 22 (Block 54) and the write process comes to an end. A match of the two addresses indicates that the write request is a part of the atomic access initiated by the previously received atomic read request. The writing process completes the atomic access, and accordingly, the busy flag is cleared.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. Apparatus for controlling atomic access to a memory by at least one client, comprising:
an access request evaluator for receiving an atomic access request to an address in the memory from a client, and determining whether to allow atomic access to the requested address;
an access indicator for indicating whether a select address is currently under atomic access in the memory; and
an access release for indicating whether the atomic access is completed at the select address;
wherein the access request evaluator enables the client atomic access to the requested address if the access indicator indicates that the requested address is currently not under atomic access.

2. The apparatus as defined in claim 1, wherein the access indicator stores the select address of the memory currently under atomic access, and a flag indicating that the select address is currently under atomic access.

3. The apparatus as defined in claim 2, wherein the flag in said access indicator is stored in a flip-flop.

4. The apparatus as defined in claim 2, wherein the access release compares the select address currently under atomic access with the requested address when the atomic access request is a write request, and clears the flag in the access indicator when the select address matches the requested address.

5. The apparatus as defined in claim 4, wherein the access release comprises a comparator.

6. The apparatus as defined in claim 1, wherein the memory is a RAM or a flash memory.

7. The apparatus as defined in claim 1, wherein the access request evaluator prevents the client atomic access to the requested address if the atomic access request is an atomic read request and the access indicator indicates that the requested address is currently under atomic access.

8. The apparatus as defined in claim 7, wherein the access request evaluator enables the client access to the requested address if the atomic access request is a write request and the requested address is currently under atomic access.

9. The apparatus as defined in claim 8, wherein the access release compares the select address currently under atomic access with the requested address when the atomic access request is a write request, and clears the flag in the access indicator when the select address matches the requested address.

10. The apparatus as defined in claim 1, further comprising an arbitration controller for arbitrating access requests to the memory between at least two clients.

11. The apparatus as defined in claim 10, wherein the arbitration controller controls atomic access requests to the memory from the clients based on instructions received from the access request evaluator.

12. A method for controlling atomic access to a memory by at least one client, comprising:
providing an atomic access controller in parallel with an arbitration controller for arbitrating access requests to the memory between at least two clients;
enabling the atomic access controller to receive an atomic access request to an address in the memory from a client and determine whether to allow atomic access to the requested address, based on whether the requested address is currently under atomic access in the memory;
wherein the atomic access controller enables the client atomic access to the requested address if the access indicator indicates that the requested address is currently not under atomic access.

13. The method as defined in claim 12, wherein the atomic access controller stores a select address of the memory currently under atomic access, and a flag indicating that the select address is currently under atomic access.

14. The method as defined in claim 13, wherein the atomic access controller clears the flag when the atomic access to the select address is completed.

15. The method as defined in claim 12, wherein the atomic access controller prevents the client atomic access to the requested address if the atomic access request is an atomic read request and the requested address is currently under atomic access.

16. The method as defined in claim 15, wherein the atomic access controller compares the select address currently under atomic access with the requested address when the atomic access request is a write request, and clears the flag indicating that the select address is currently under atomic access when the select address matches the requested address.

17. The method as defined in claim 12, wherein the arbitration controller controls atomic access requests to the memory from the clients based on instructions received from the atomic access controller.
